(19) United States
(12) Patent Application Publication
(10) Pub. No.: US 2009/0064255 A1
(43) Pub. Date: Mar. 5, 2009

(54) SYSTEM AND METHOD OF PROVIDING PERFORMANCE DATA

(75) Inventors: Baofeng Jiang, Pleasanton, CA (US); Donald Garofalo, Austin, TX (US); Kaiyan Chen, Pleasanton, CA (US)

Correspondence Address: TOLER LAW GROUP, 8500 BLUFFSTONE COVE, SUITE A201, AUSTIN, TX, 78759, US

(73) Assignee: AT&T Knowledge Ventures, LP, Reno, NV (US)

(21) Appl. No.: 11/845,428

(22) Filed: Aug. 27, 2007

(51) Int. Cl. H04N 7/173

(52) U.S. Cl. 725/118

(57) ABSTRACT

A method of providing performance data is disclosed that includes sending a data packet from customer premises equipment to a set-top box device via a network path at a transmission rate. The transmission rate is based on Network Layer performance metrics associated with the network path. The method also includes receiving performance data at the customer premises equipment from the set-top box device. The performance data relates to Physical Layer measurements. In addition, the performance data indicates a condition of a physical component of the network path.

### FIELD OF THE DISCLOSURE

The present disclosure is generally related to systems and methods of providing performance data.

### BACKGROUND

The condition of physical components included in a video distribution network can affect the quality of service delivered to subscribers. For example, a loose connection at a network device or poor wire quality can degrade the quality of video content provided to a subscriber. However, data related to the condition of physical components of a network path within a subscriber premises can be difficult to collect proactively; that is, prior to a subscriber's complaint. Hence, there is a need for an improved system and method of providing performance data.

### BRIEF DESCRIPTION OF THE DRAWINGS

FIG. 1 is a block diagram of a particular embodiment of a system to provide performance data;

FIG. 2 is a block diagram of a second particular embodiment of a system to provide performance data;

FIG. 3 is a block diagram of a third particular embodiment of a system to provide performance data;

FIG. 4 is a block diagram of a fourth particular embodiment of a system to provide performance data;

FIG. 5 is a flow diagram of a particular embodiment of a method of providing performance data;

FIG. 6 is a flow diagram of a second particular embodiment of a method of providing performance data; and

FIG. 7 is a block diagram of an illustrative embodiment of a general computer system.

### DETAILED DESCRIPTION OF THE DRAWINGS

A system to provide performance data is disclosed that includes processing logic and memory accessible to the processing logic. The memory includes instructions executable by the processing logic to send a data packet to a set-top box device via a network path at a transmission rate. The transmission rate is based on Network Layer performance metrics associated with the network path. The memory also includes instructions executable by the processing logic to receive performance data at the customer premises equipment from the set-top box device. The performance data is related to Physical Layer measurements. In addition, the performance data indicates a condition of a physical component of the network path.

In another embodiment, a set-top box device is disclosed that includes a processor and memory accessible to the processor. The memory includes a performance data collection module executable by the processor to collect performance data associated with Physical Layer measurements. The Physical Layer measurements are associated with data packets received at the set-top box device and the performance data indicates a condition of a physical component of a network path associated with the set-top box device. The memory also includes a performance data storage module executable by the processor to store the collected performance data at a data storage device associated with the set-top box device. In addition, the memory includes a performance data delivery module executable by the processor to send performance data to customer premises equipment via the network path.

In another embodiment, a method of providing performance data is disclosed that includes sending a first data packet from first customer premises equipment to a first set-top box device via a first network path at a transmission rate. The transmission rate is based on Network Layer performance metrics associated with the first network path. The method also includes receiving performance data at the first customer premises equipment from the first set-top box device. The performance data is related to Physical Layer measurements. In addition, the performance data indicates a condition of a physical component of the first network path.

In another embodiment, a method of providing performance data is disclosed that includes receiving performance data from a video content provider network device. The performance data is related to Physical Layer measurements associated with a network path between customer premises equipment and a set-top box device. The method also includes predicting a condition of a physical component associated with the network path based on the performance data.

In another embodiment, a computer-readable medium is disclosed having instructions to cause a processor to execute a method that includes sending a data packet from customer premises equipment to a set-top box device via a network path at a transmission rate. The transmission rate is based on Network Layer performance metrics associated with the network path. The computer-readable medium also includes instructions to cause the processor to execute a method that includes receiving performance data at the customer premises equipment from the set-top box device. The performance data is related to Physical Layer measurements. In addition, the performance data indicates a condition of a physical component of the network path.

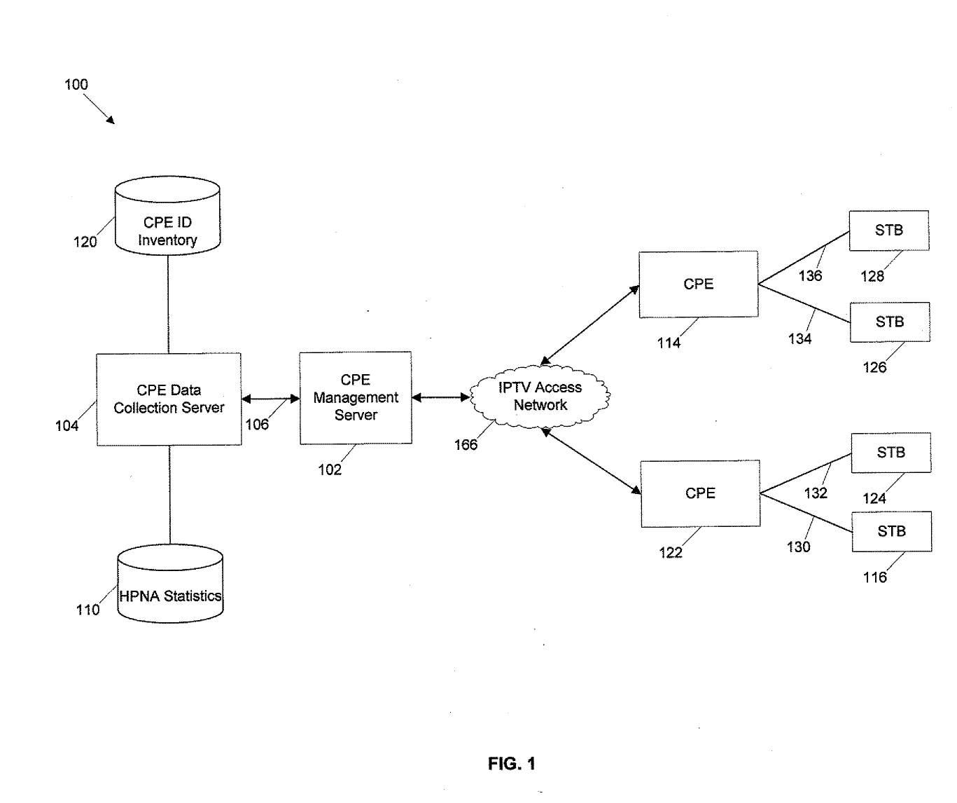

Referring to FIG. 1, a communication system 100 that may be used to provide performance data is illustrated. The system 100 includes a customer premises equipment (CPE) data collection server 104 that communicates with a home phoneline network alliance (HPNA) statistics data store 110, a customer premises equipment (CPE) inventory data store 120, and a CPE management server 102. In an illustrative embodiment, the CPE management server 102 can be coupled to the CPE data collection server 104 via a Web service interface 106.

The system 100 further includes customer premises equipment, such as representative CPE units 114 and 122. The CPE units 114 and 122 may each include a router, a local area network device, a modem, such as a digital subscriber line (DSL) modem, a residential gateway, a home network gateway device, or any combination thereof. The CPE units 114 and 122 may be located within a subscriber premises, outside of a subscriber premises, or any combination thereof. The CPE unit 122 is coupled to a plurality of set-top box devices, such as a first representative set-top box device 116 and a second representative set-top box device 124. The CPE unit 122 is coupled to the first representative set-top box device 116 via a first communication link 130 and the CPE unit 122 is coupled to the second representative set-top box device 124 via a second communication link 132. The CPE unit 114 is coupled to a plurality of set-top box devices, such as set-top box devices 126 and 128. The CPE unit 114 is coupled to the set-top box device 126 via a communication link 134 and the CPE unit 114 is coupled to the set-top box device 128 via a communication link 136. Various communication link technologies may be used to support communication of data, such as Internet Protocol Television (IPTV) data, via the communication links 130, 132, 134, and 136.

Each of the CPE units 114 and 122 communicate with the CPE management server 102 via an IPTV access network 166. The CPE management server 102 may communicate with the CPE units 114, 122 according to a CPE wide area network (WAN) management protocol, such as Technical Report 69 (TR69).

In a particular embodiment, the CPE data collection server 104 may send a request to the CPE management server 102 via the Web service interface 106 to receive performance data associated with a network path between a CPE unit and one or more set-top box devices. For example, the network path may include the communication link 130 between the CPE unit 122 and the set-top box device 116. The performance data may relate to a condition of a physical component of the particular network path. The request may be sent periodically, such as every 5 minutes, at a fixed time, such as at 2:00 A.M. each morning, in response to a particular event, such as a customer complaint regarding the performance of a particular set-top box device, or any combination thereof. The requested performance data may be stored at a data storage device associated with a respective CPE unit 114, 122.

The CPE management server 102 may verify that a request for performance data is associated with a validated CPE unit by use of CPE access certificates associated with the CPE units of the system 100. The CPU management server 102 may also translate a request for performance data received from the CPE data collection server 104 to a CPE WAN management protocol before sending a performance data request to a particular CPE unit.

The CPE inventory data store 120 may store information related to each of the CPE units of the system 100. In an illustrative embodiment, the CPE information may indicate set-top box devices that may be accessed via a particular CPE unit and the physical components of the network path between the particular CPE unit and its respective set-top box devices. For example, the CPE information may indicate that the set-top box devices 116, 124 are accessible via the CPE unit 122 via the communication links 130 and 132, respectively and that the communication links 130 and 134 each include a splitter. The CPE information may also indicate when performance data should be collected from each respective set-top box device, when performance data should be received from each respective set-top box device, or any combination thereof.

In a particular embodiment, the CPE unit 122 may send a video content data packet to the set-top box device 116 at a particular transmission rate. The transmission rate may be based on Network Layer performance measurements associated with the communication link 130, such that a particular standard of video content quality is provided. For example, a specified maximum number of error seconds over a certain amount of time may need to be maintained to provide a desired standard of video content quality. Thus, the transmission rate is selected in order to support the required maximum amount of error seconds.

The set-top box device 116 may collect performance data related to Physical Layer measurements associated with receiving the video content data packet. For example, the set-top box device 116 may determine a rate associated with the received video content data packet, a signal quality of the received video content data packet, or any combination thereof. The set-top box device 116 may also determine the number of errored data packets associated with the set-top box device 116 at the time that the video content data packet is received. The set-top box device 116 may be adapted to store the performance data at a data storage device associated with the set-top box device 116. The set-top box device 116 may also be adapted to send the performance data associated with the video content data packet to the CPE unit 122.

The CPE unit 122 may be adapted to store collected performance data and to communicate such data to the CPE management server 102 via the IPTV access network 166 in response to receiving a performance data request, periodically, at a fixed time, in response to a particular event, such as identifying performance data within a predetermined range, or any combination thereof. The CPE management server 102 may receive performance data from a plurality of CPE units and forward the performance data to the HPNA statistics data store 110 via the Web service interface 106 and via the CPE data collection server 104. The CPE data collection server 104 may be adapted to identify a condition of a physical component associated with a particular network path based on received performance data, to predict a condition of a physical component associated with a particular network path based on received performance data, or any combination thereof. In an illustrative embodiment, the CPE data collection server 104 may be adapted to identify the condition of a physical component of the communication link 130 based on real-time or near real-time performance data received at the CPE data collection server 104 from the set-top box device 116. Further, the CPE data collection server 104 may be adapted to predict the condition of a physical component of the communication link 130 based on a trend indicated by data collected from the set-top box device 116 over a specified period of time. In an illustrative, non-limiting embodiment, the CPU data collection server 104 may be adapted to identify or predict a faulty physical component associated with the communication link 130 based on received performance data. The faulty physical component associated with the communication link 130 may include a faulty connection, a faulty device, faulty wiring, or any combination thereof.

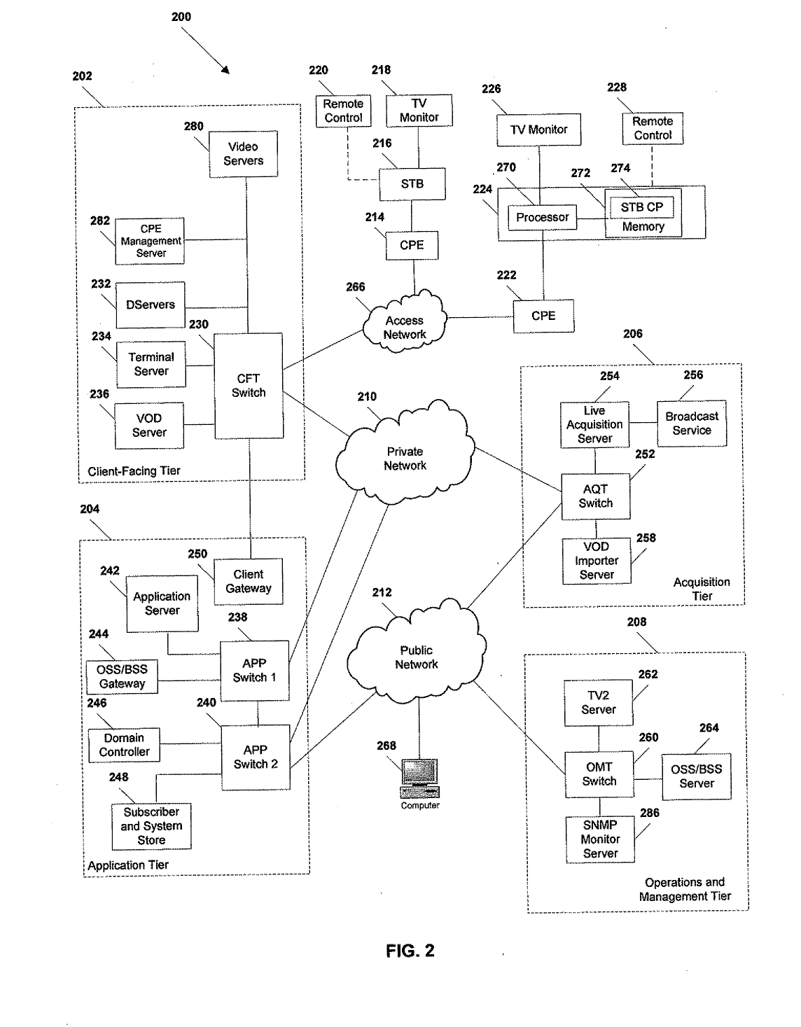

Referring to FIG. 2, an illustrative embodiment of an Internet Protocol Television (IPTV) system that may be used to provide performance data is illustrated and is generally designated 200. As shown, the system 200 can include a client facing tier 202, an application tier 204, an acquisition tier 206, and an operations and management tier 208. Each tier 202, 204, 206, 208 is coupled to a private network 210; to a public network 212, such as the Internet; or to both the private network 210 and the public network 212. For example, the client-facing tier 202 can be coupled to the private network 210. Further, the application tier 204 can be coupled to the private network 210 and to the public network 212. The acquisition tier 206 can also be coupled to the private network 210 and to the public network 212. Additionally, the operations and management tier 208 can be coupled to the public network 222.

As illustrated in FIG. 2, the various tiers 202, 204, 206, 208 communicate with each other via the private network 210 and the public network 212. For instance, the client-facing tier 202 can communicate with the application tier 204 and the acquisition tier 206 via the private network 210. The application tier 204 can communicate with the acquisition tier 206 via the private network 210. Further, the application tier 204 can communicate with the acquisition tier 206 and the operations and management tier 208 via the public network 212. Moreover, the acquisition tier 206 can communicate with the operations and management tier 208 via the public network 212. In a particular embodiment, elements of the application tier 204, including, but not limited to, a client gateway 250, can communicate directly with the client-facing tier 202.

The client-facing tier 202 can communicate with user equipment via an access network 266, such as an Internet Protocol Television (IPTV) access network. In an illustrative embodiment, customer premises equipment (CPE) 214, 222 can be coupled to a local switch, router, or other device of the access network 266. The client-facing tier 202 can communicate with a first representative set-top box device 216 via the first CPE 214 and with a second representative set-top box device 224 via the second CPE 222. In a particular embodiment, the first representative set-top box device 216 and the first CPE 214 can be located at a first customer premise, and the second representative set-top box device 224 and the second CPE 222 can be located at a second customer premise. In another particular embodiment, the first representative set-top box device 216 and the second representative set-top box device 224 can be located at a single customer premise, both coupled to one of the CPE 214, 222. The CPE 214, 222 can include routers, local area network devices, modems, such as digital subscriber line (DSL) modems, any other suitable devices for facilitating communication between a set-top box device and the access network 266, or any combination thereof.

In an exemplary embodiment, the client-facing tier 202 can be coupled to the CPE 214, 222 via fiber optic cables. In another exemplary embodiment, the CPE 214, 222 can include digital subscriber line (DSL) modems that are coupled to one or more network nodes via twisted pairs, and the client-facing tier 202 can be coupled to the network nodes via fiber-optic cables. Each set-top box device 216, 224 can process data received via the access network 266, via an IPTV software platform, such as Microsoft® TV IPTV Edition.

The first set-top box device 216 can be coupled to a first external display device, such as a first television monitor 218, and the second set-top box device 224 can be coupled to a second external display device, such as a second television monitor 226. Moreover, the first set-top box device 216 can communicate with a first remote control 220, and the second set-top box device 224 can communicate with a second remote control 228. The set-top box devices 216, 224 can include IPTV set-top box devices; video gaming devices or consoles that are adapted to receive IPTV content; personal computers or other computing devices that are adapted to emulate set-top box device functionalities; any other device adapted to receive IPTV content and transmit data to an IPTV system via an access network; or any combination thereof.

In an exemplary, non-limiting embodiment, each set-top box device 216, 224 can receive data, video, or any combination thereof, from the client-facing tier 202 via the access network 266 and render or display the data, video, or any combination thereof, at the display device 218, 226 to which it is coupled. In an illustrative embodiment, the set-top box devices 216, 224 can include tuners that receive and decode television programming signals or packet streams for transmission to the display devices 218, 226. Further, the set-top box devices 216, 224 can each include a STB processor 270 and a STB memory device 272 that is accessible to the STB processor 270. In one embodiment, a computer program, such as the STB computer program 274, can be embedded within the STB memory device 272.

In an illustrative embodiment, the client-facing tier 202 can include a client-facing tier (CFT) switch 230 that manages communication between the client-facing tier 202 and the access network 266 and between the client-facing tier 202 and the private network 210. As illustrated, the CFT switch 230 is coupled to one or more distribution servers, such as D-servers 232, that store, format, encode, replicate, or otherwise manipulate or prepare video content for communication from the client-facing tier 202 to the set-top box devices 216, 224. The CFT switch 230 can also be coupled to a terminal server 234 that provides terminal devices with a point of connection to the IPTV system 200 via the client-facing tier 202. In a particular embodiment, the CFT switch 230 can be coupled to a video-on-demand (VOD) server 236 that stores or provides VOD content imported by the IPTV system 200. Further, the CFT switch 230 is coupled to one or more video servers 280 that receive video content and transmit the content to the set-top boxes 216, 224 via the access network 266. The client-facing tier 202 may include a CPE management server 282 that manages communications to and from the CPE 214 and the CPE 222. For example, the CPE management server 282 may collect performance data associated with the set-top box devices 216, 224 from the CPE 214 or the CPE 222 and forward the collected performance data to a server associated with the operations and management tier 208.

In an illustrative embodiment, the client-facing tier 202 can communicate with a large number of set-top boxes, such as the representative set-top boxes 216, 224, over a wide geographic area, such as a metropolitan area, a viewing area, a statewide area, a regional area, a nationwide area or any other suitable geographic area, market area, or subscriber or customer group that can be supported by networking the client-facing tier 202 to numerous set-top box devices. In a particular embodiment, the CFT switch 230, or any portion thereof, can include a multicast router or switch that communicates with multiple set-top box devices via a multicast-enabled network.

As illustrated in FIG. 2, the application tier 204 can communicate with both the private network 210 and the public network 212. The application tier 204 can include a first application tier (APP) switch 238 and a second APP switch 240. In a particular embodiment, the first APP switch 238 can be coupled to the second APP switch 240. The first APP switch 238 can be coupled to an application server 242 and to an OSS/BSS gateway 244. In a particular embodiment, the application server 242 can provide applications to the set-top box devices 216, 224 via the access network 266, which enable the set-top box devices 216, 224 to provide functions, such as interactive program guides, video gaming, display, messaging, processing of VOD material and other IPTV content, etc. In an illustrative embodiment, the application server 242 can provide location information to the set-top box devices 216, 224. In a particular embodiment, the OSS/BSS gateway 244 includes operation systems and support (OSS) data, as well as billing systems and support (BSS) data. In one embodiment, the OSS/BSS gateway 244 can provide or restrict access to an OSS/BSS server 264 that stores operations and billing systems data.

The second APP switch 240 can be coupled to a domain controller 246 that provides Internet access, for example, to users at their computers 268 via the public network 212. For example, the domain controller 246 can provide remote Internet access to IPTV account information, e-mail, personalized Internet services, or other online services via the public network 212. In addition, the second APP switch 240 can be coupled to a subscriber and system store 248 that includes account information, such as account information that is associated with users who access the IPTV system 200 via the private network 210 or the public network 212. In an illustrative embodiment, the subscriber and system store 248 can store subscriber or customer data and create subscriber or customer profiles that are associated with IP addresses, stock-keeping unit (SKU) numbers, other identifiers, or any combination thereof of corresponding set-top box devices 216, 224. In another illustrative embodiment, the subscriber and system store can store data associated with capabilities of set-top box devices associated with particular customers.

In a particular embodiment, the application tier 204 can include a client gateway 250 that communicates data directly to the client-facing tier 202. In this embodiment, the client gateway 250 can be coupled directly to the CFT switch 230. The client gateway 250 can provide user access to the private network 210 and the tiers coupled thereto. In an illustrative embodiment, the set-top box devices 216, 224 can access the IPTV system 200 via the access network 266, using information received from the client gateway 250. User devices can access the client gateway 250 via the access network 266, and the client gateway 250 can allow such devices to access the private network 210 once the devices are authenticated or verified Similarly, the client gateway 250 can prevent unauthorized devices, such as hacker computers or stolen set-top box devices from accessing the private network 210, by denying access to these devices beyond the access network 266.

For example, when the first representative set-top box device 216 accesses the client-facing tier 202 via the access network 266, the client gateway 250 can verify subscriber information by communicating with the subscriber and system store 248 via the private network 210. Further, the client gateway 250 can verify billing information and status by communicating with the OSS/BSS gateway 244 via the private network 210. In one embodiment, the OSS/BSS gateway 244 can transmit a query via the public network 212 to the OSS/BSS server 264. After the client gateway 250 confirms subscriber and/or billing information, the client gateway 250 can allow the set-top box device 216 to access IPTV content and VOD content at the client-facing tier 202. If the client gateway 250 cannot verify subscriber information for the set-top box device 216, e.g., because it is connected to an unauthorized twisted pair, the client gateway 250 can block transmissions to and from the set-top box device 216 beyond the access network 266.

As indicated in FIG. 2, the acquisition tier 206 includes an acquisition tier (AQT) switch 252 that communicates with the private network 210. The AQT switch 252 can also communicate with the operations and management tier 208 via the public network 212. In a particular embodiment, the AQT switch 252 can be coupled to a live acquisition server 254 that receives or acquires television content, movie content, advertisement content, other video content, or any combination thereof from a broadcast service 256, such as a satellite acquisition system or satellite head-end office. In a particular embodiment, the live acquisition server 254 can transmit content to the AQT switch 252, and the AQT switch 252 can transmit the content to the CFT switch 230 via the private network 210.

In an illustrative embodiment, content can be transmitted to the D-servers 232, where it can be encoded, formatted, stored, replicated, or otherwise manipulated and prepared for communication from the video server(s) 280 to the set-top box devices 216, 224. The CFT switch 230 can receive content from the video server(s) 280 and communicate the content to the CPE 214, 222 via the access network 266. The set-top box devices 216, 224 can receive the content via the CPE 214, 222, and can transmit the content to the television monitors 218, 226. In an illustrative embodiment, video or audio portions of the content can be streamed to the set-top box devices 216, 224.

Further, the AQT switch 252 can be coupled to a video-on-demand importer server 258 that receives and stores television or movie content received at the acquisition tier 206 and communicates the stored content to the VOD server 236 at the client-facing tier 202 via the private network 210. Additionally, at the acquisition tier 206, the video-on-demand (VOD) importer server 258 can receive content from one or more VOD sources outside the IPTV system 200, such as movie studios and programmers of non-live content. The VOD importer server 258 can transmit the VOD content to the AQT switch 252, and the AQT switch 252, in turn, can communicate the material to the CFT switch 230 via the private network 210. The VOD content can be stored at one or more servers, such as the VOD server 236.

When users issue requests for VOD content via the set-top box devices 216, 224, the requests can be transmitted over the access network 266 to the VOD server 236, via the CFT switch 230. Upon receiving such requests, the VOD server 236 can retrieve the requested VOD content and transmit the content to the set-top box devices 216, 224 across the access network 266, via the CFT switch 230. The set-top box devices 216, 224 can transmit the VOD content to the television monitors 218, 226. In an illustrative embodiment, video or audio portions of VOD content can be streamed to the set-top box devices 216, 224.

FIG. 2 further illustrates that the operations and management tier 208 can include an operations and management tier (OMT) switch 260 that conducts communication between the operations and management tier 208 and the public network 212. In the embodiment illustrated by FIG. 2, the OMT switch 260 is coupled to a TV2 server 262. Additionally, the OMT switch 260 can be coupled to an OSS/BSS server 264 and to a simple network management protocol (SNMP) monitor 286 that monitors network devices within or coupled to the IPTV system 200. In a particular embodiment, the OMT switch 260 can communicate with the AQT switch 252 via the public network 212. The OSS/BSS server 264 may include a cluster of servers, such as one or more CPE data collection servers that are adapted to request and store operations systems data, such as performance data from the set-top box devices 216, 224. In an illustrative embodiment, the CPE data collection servers may be adapted to analyze performance data to identify a condition of a physical component of a network path associated with a set-top box device, to predict a condition of a physical component of a network path associated with a set-top box device, or any combination thereof.

In an illustrative embodiment, the live acquisition server 254 can transmit content to the AQT switch 252, and the AQT switch 252, in turn, can transmit the content to the OMT switch 260 via the public network 212. In this embodiment, the OMT switch 260 can transmit the content to the TV2 server 262 for display to users accessing the user interface at the TV2 server 262. For example, a user can access the TV2 server 262 using a personal computer 268 coupled to the public network 212.

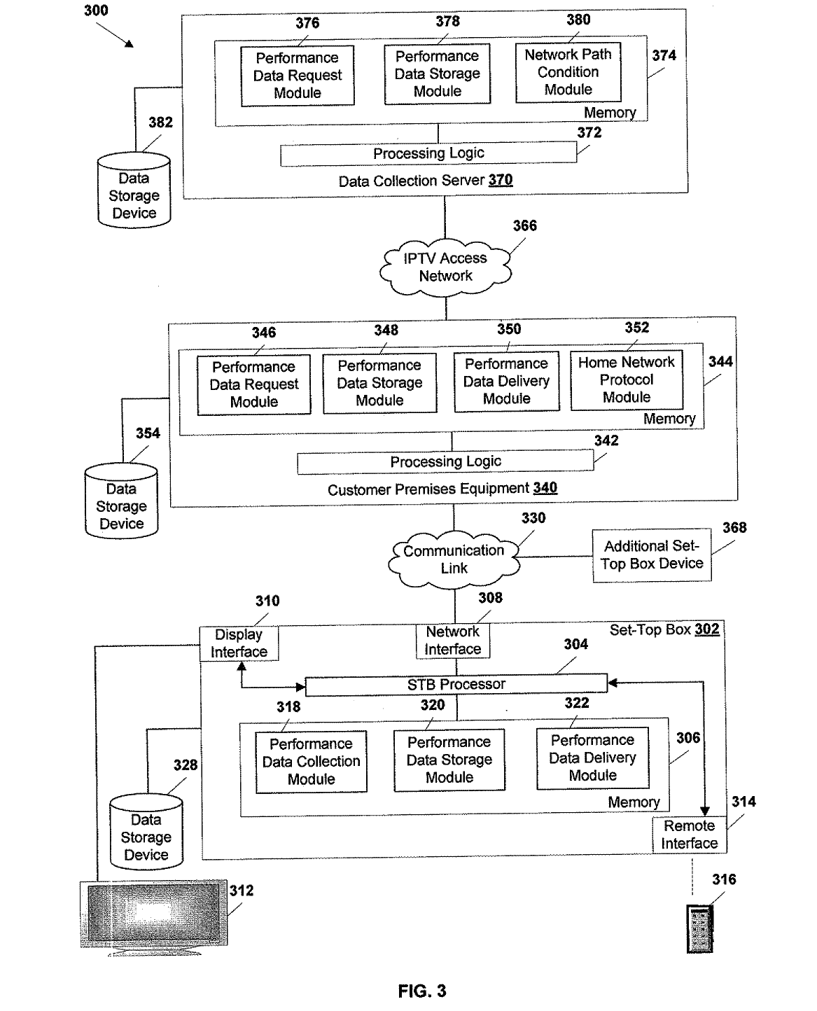

Referring to FIG. 3, a particular embodiment of a system that may be used to provide performance data is illustrated and generally designated 300. The system 300 includes representative customer premises equipment (CPE) 340, a communication link and associated network 330, and a representative set-top box (STB) device 302. The system 300 also includes an Internet Protocol Television (IPTV) access network 366, an additional set-top box device 368, and a data collection server 370, The set-top box device 302 communicates with the CPE 340 via the communication link 330. The set-top box device 302 is also coupled to a display device 312 and is coupled via a memory interface (not shown) to a data storage device 328. In addition, the set-top box device 302 is coupled for communication via remote interface 314 to a remote control device 316. The CPE 340 is coupled to a data storage device 354 and communicates with the data collection server 370 via the IPTV access network 366. Further, the CPE 340 and the set-top box device 302 may communicate with the additional set-top box device 368 via the communication link 330. In an illustrative, non-limiting embodiment, the set-top box device 302 and the additional set-top box device 368 may be located within the same subscriber residence.

The set-top box device 302 includes a network interface 308 for access to the communication link 330 and includes a display interface 310 for access to the display device 312. The network interface 308 and the display interface 310 are coupled to a STB processor 304. The STB processor 304 is also coupled to the remote interface 314 and memory 306. The memory 306 includes a plurality of executable software modules including a performance data collection module 318, a performance data storage module 320, and a performance data delivery module 322.

In a particular embodiment, the performance data collection module 318 is executable by the STB processor 304 to collect performance data associated with Physical Layer measurements. The performance data may indicate a condition of a physical component of a network path associated with the set-top box device 302. The network path associated with the set-top box device 302 may include devices, wiring, cable, or any combination thereof, connecting the set-top box device 302 with the CPE 340, with the additional set-top box device 368, or any combination thereof. For example, the network path may include twisted pair copper wire, coaxial cable, optical fibers, one or more splitters, one or more diplexers, one or more baluns, one or more home network devices, or any combination thereof. In an illustrative embodiment, a condition of a physical component of the network path may relate to one or more connections of devices associated with the network path, wire quality associated with the network path, a faulty device associated with the network path, or any combination thereof.

The Physical Layer measurements may be associated with data packets received at the set-top box device 302. For example, the Physical Layer measurements may relate to a rate of a data packet received at the set-top box device 302, a signal quality associated with a data packet received at the first set-top box device 302, a number of errored data packets received at the set-top box device 302, or any combination thereof. Data packets received at the set-top box device 302 may include video content data packets, test data packets, control information data packets, other IPTV information data packets, or any combination thereof. In an illustrative, non-limiting embodiment, data packets received at the set-top box device 302 may be received from the CPE 340, the additional set-top box device 368, or any combination thereof.

In an illustrative embodiment, the performance data collection module 318 may be executable by the STB processor 304 to collect performance data in response to receiving a performance data request for certain Physical Layer measurements from the CPE 340. For example, the performance data request may correspond to the rate of data packets received at the set-top box device 302 at a particular time. In another embodiment, the performance data collection module 318 may be executable by the STB processor 304 to automatically collect performance data periodically, at a specified time, in response to a particular event, or any combination thereof, independent of any interaction from a subscriber associated with the set-top box device 302.

In a particular embodiment, the performance data storage module 320 is adapted to store collected performance data at the data storage device 328. In an illustrative embodiment, the data storage module 320 may be executable by the STB processor 304 to store collected performance data for a specified period of time and then overwrite the stored performance data with newly collected performance data. In another illustrative embodiment, the performance data storage module 320 may be executable by the STB processor 304 to store a specified amount of collected performance data and then overwrite the stored performance data with newly collected performance data.

In a particular embodiment, the performance data delivery module 322 is executable by the STB processor 304 to send performance data to the CPE 340. In an illustrative embodiment, the performance data delivery module 322 may be executable by the STB processor 304 to send the performance data to the CPE 340 in response to receiving a request for the performance data from the CPE 340. In an illustrative, non-limiting embodiment, the performance data delivery module 322 may be executable by the STB processor 304 to send real-time or near real-time performance data to the CPE 340 in response to receiving the performance data request. Further, the performance data delivery module 322 may be executable by the STB processor 304 to send performance data collected over a specified period of time and stored at the data storage device 328 to the CPE 340 in response to receiving the performance data request.

In another illustrative embodiment, the performance data delivery module 322 is executable by the STB processor 304 to automatically send the performance data to the CPE 340. For example, the performance data delivery module 322 may be executable by the STB processor 304 to periodically send specified performance data to the CPE 340. In another example, the performance data delivery module 322 is executable by the STB processor 304 to send specified performance data measurements to the CPE 340 in response to determining that values associated with the specified performance data measurements are outside of a predetermined range.

The CPE 340 includes processing logic 342 and memory 344 accessible to the processing logic 342. The memory 344 includes a performance data request module 346, a performance data storage module 348, a performance data delivery module 350, and a home network protocol module 352. In an illustrative embodiment, the CPE 340 may include a home network gateway device, a router, a local area network device, a modem, such as a digital subscriber line (DSL) modem, a residential gateway, any other suitable device for facilitating communication between the network interface 308 of the set-top box device 302 and the private IPTV access network 366, or any combination thereof. The CPE 340 may be located outside of a subscriber residence, inside a subscriber residence, or any combination thereof. In an illustrative, non-limiting embodiment, the CPE 340 may be a home network gateway device located inside of a subscriber residence and the CPE 340 may be adapted to communicate with a second customer premises equipment (not shown), such as a video content provider residential gateway located outside of the subscriber residence. The second customer premises equipment may be adapted to facilitate communication between the CPE 340 and the IPTV access network 366.

In a particular embodiment, the performance data request module 346 is executable by the processing logic 342 to send a performance data request to a set-top box device, such as the set-top box device 302. The performance data request may automatically be sent to the set-top box device 302 periodically or in response to receiving a request for performance data from a network device, such as the data collection server 370. The performance data request may include one or more data packets that include information indicating the requested performance data. Further, the performance data request module 346 may be executable by the processing logic 342 to send test data packets to the set-top box device 302 and receive performance data related to the test data packets from the set-top box device 302.

In an illustrative embodiment, the performance data request module 346 may be executable by the processing logic 342 to send a data packet to the set-top box device 302 at a particular transmission rate. The transmission rate may be based on Network Layer performance metrics associated with a network path between the CPE 340 and the set-top box device 302. The Network Layer performance metrics may include code violation, error seconds, severe error seconds, Ethernet frame cyclic redundancy checks (CRCs), Ethernet frames dropped, or any combination thereof. In an illustrative, non-limiting embodiment, the performance data request module 346 may be executable by the processing logic 342 to send a data packet to the set-top box device 302 at a transmission rate that supports a specified number of error seconds. The specified number of error seconds may correspond to an acceptable quality of video content provided to the set-top box device 302.

Further, the performance data request module 346 may be executable by the processing logic 342 to send a data packet to the additional set-top box device 368 at a particular transmission rate. In an illustrative, non-limiting embodiment, the performance data request module 346 maybe executable by the processing logic 342 to send data packets to the set-top box device 302 and to the additional set-top box device 368 at a transmission rate based on Network Layer performance metrics associated with a network path between the CPE 340 and the set-top box device 302, a network path between the CPE 340 and the additional set-top box device 368, or any combination thereof. For example, the performance data request module 346 may be executable by the processing logic 342 to send data packets to both the set-top box device 302 and the additional set-top box device 368 at a transmission rate that supports a specified number of error seconds for both the network path between the CPE 340 and the set-top box device 302 and the network path between the CPE 340 and the additional set-top box device 368.

In a particular embodiment, the performance data storage module 348 is adapted to store performance data received from the set-top box device 302 at the data storage device 354. Further, the performance data delivery module 350 is executable by the processing logic 342 to send performance data received from the set-top box device 302 to a predetermined IPTV network device, to the IPTV network device that requested the performance data measurements, or any combination thereof. For example, the performance data delivery module 350 may be executable by the processing logic 342 to send performance data to the data collection server 370.

In an illustrative embodiment, the performance data delivery module 350 may be executable by the processing logic 342 to send performance data stored at the data storage device 354 to the data collection server 370. In an illustrative, non-limiting embodiment, the performance data delivery module 350 may be executable by the processing logic 342 to send stored performance data periodically, at a specified time, in response to a particular event, in response to receiving a performance data request from the data collection server 370, or any combination thereof. In another illustrative embodiment, the performance data delivery module may be executable by the processing logic 342 to forward performance data to the data collection server 370 in real-time or near real-time as the performance data is received at the CPE 340 from the set-top box device 302.

In a particular embodiment, the home network protocol module 352 is executable by the processing logic 342 to convert data received via the IPTV access network 366 to a home network protocol, such as a home phoneline network alliance (HPNA) protocol. The home network protocol module 352 may also be executable by the processing logic 342 to convert data received from the set-top box device 302 from a home network protocol to a CPE management protocol, such as Technical Report 69 (TR69). In an illustrative embodiment, the home network protocol module 352 may be executable by the processing logic 342 to send data formatted according to the home network protocol via the communication link 330 at a higher frequency than data received at the CPE 340 from the IPTV access network 366.

In a particular embodiment, the data collection server 370 includes processing logic 372 and memory 374 accessible to the processing logic 372. The memory 374 includes a performance data request module 376, a performance data storage module 378, and a network path condition module 380. The performance data request module 376 is executable by the processing logic 372 to send a request for performance data to the CPE 340. In an illustrative embodiment, the performance data may be associated with a network path between the CPE 340 and a set-top box device, such as the set-top box device 302, the additional set-top box device 368, or any combination thereof. The performance data request module 376 may be executable by the processing logic 372 to send a performance data request to the CPE 340 periodically, at a specified time, in response to a particular event, or any combination thereof. In an illustrative, non-limiting embodiment, the performance data request module 376 may be executable by the processing logic 372 to send a performance data request to the CPE 340 in response to a command from a video content provider agent after receiving a complaint from a subscriber associated with a set-top box device, such as the set-top box device 302, the additional set-top box device 368, or any combination thereof. Additionally, the performance data request module 376 may be executable by the processing logic 372 to automatically send the performance data request to the CPE 340 independent of subscriber interaction.

In a particular embodiment, the performance data storage module 378 is adapted to store received performance data at a data storage device coupled to the data collection server 370, such as the data storage device 382. The data storage device 382 may include a home phoneline network alliance (HPNA) statistics data storage device.

In a particular embodiment, the network path condition module 380 is executable by the processing logic 372 to analyze performance data received from the CPE 340. The performance data may be related to Physical Layer measurements associated with a network path between the CPE 340 and the set-top box device 302, a network path between the CPE 340 and the additional set-top box device 368, or any combination thereof. The analyzed performance data may be stored at the data storage device 382, may be real-time or near real-time performance data, or any combination thereof.

In an illustrative embodiment, the network path condition module 380 may be executable by the processing logic 372 to identify a condition of a physical component of a network path associated with the CPE 340. For example, the network path condition module 380 may be executable by the processing logic 372 to compare performance data received from the set-top box device 302 to at least one performance data metric, such as a range of measurements related to the performance data, a threshold related to the performance data, or any combination thereof, that indicates a condition of a physical component of a network path between the CPE 340 and the set-top box device 302. Based on the comparison between the received performance data and the at least one performance data metric, the network path condition module 380 may be executable by the processing logic 372 to identify a faulty physical component of the network path between the CPE 340 and the set-top box device 302.

To illustrate, the network path condition module 380 may be executable by the processing logic 372 to determine that a rate of a data packet received at the set-top box device 302 falls within a below normal range indicating poor in-house wire quality between the CPE 340 and the set-top box device 302, a loose connection at the residential gateway, a loose connection at the set-top box device 302, a defective splitter coupled to the CPE 340 and the set-top box device 302, a loose connection at the port of the splitter associated with the residential gateway, a loose connection at the port of the splitter associated with the set-top box device 302, or any combination thereof.

In an illustrative, non-limiting embodiment, the set-top box device 302 may be coupled to another set-top box device located within the same subscriber residence, such as the additional set-top box device 368, and to the CPE 340 via a splitter and the network path condition module 380 may be executable by the processing logic 372 to analyze performance data associated with the additional set-top box device 368 to further identify the possible faulty components of the network path between the CPE 340 and the set-top box device 302. For example, the network path condition module 380 may be executable by the processing logic 372 to determine that a rate of a data packet received at the set-top box device 368 from the CPE 340 is within a normal range, while the rate of a data packet received at the set-top box device 302 from the CPE 340 is within a below normal range. Thus, the network path condition module 380 may be executable by the processing logic 372 to more specifically identify that the faulty physical component of the network path relates to poor in-house wiring between the splitter and the set-top box device 302, to a loose connection at the set-top box device 302, to a loose connection at the port of the splitter associated with the set-top box device 302, or any combination thereof.

In another illustrative embodiment, the network path condition module 380 is executable by the processing logic 372 to predict a condition of physical component associated with the network path based on performance data stored at the data storage device 382 relating to a particular period of time, based on real-time or near real-time performance data, or any combination thereof. For example, the network path condition module 380 may be executable by the processing logic 372 to predict a faulty condition of a component of the network path based on a trend in the performance data, based on the performance data being above or below a particular threshold, based on the performance data being within a specified range, or any combination thereof.

In a particular embodiment, the network path condition module 380 is executable by the processing logic 372 to provide a graphical user interface (GUI) indicating a condition of at least one physical component of a network path, such as the network path between the CPE 340 and the set-top box device 302. The GUI may indicate a real-time or near real-time condition of the at least one physical component of the network path, a predicted condition of at least one physical component of the network path, or any combination thereof. The GUI may be accessible to a video content provider agent, such as a technician, a customer service representative, or any combination thereof. In an illustrative, non-limiting embodiment, a video content provider agent may access the GUI to facilitate scheduling a service visit to a subscriber residence regarding a predicted faulty component of a network path, to facilitate communication with a subscriber regarding a current or predicted faulty component of a network path, or any combination thereof.

For ease of explanation, the various modules 318-322, 346-352, and 376-380 have been described in terms of processor-executable instructions. However, those skilled in the art will appreciate that such modules can be implemented as hardware logic, processor-executable instructions, or any combination thereof.

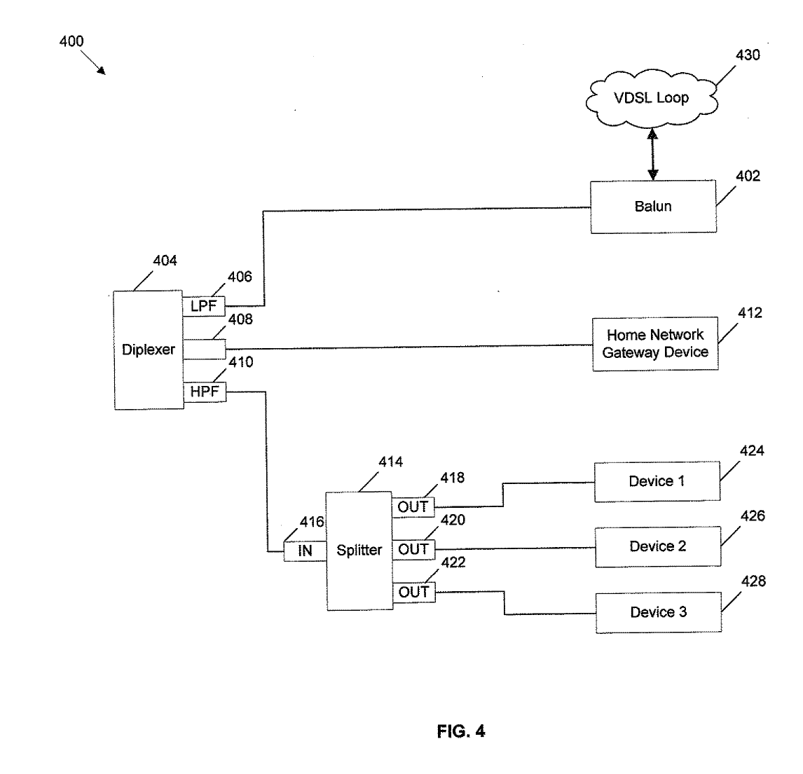

Referring to FIG. 4 a system 400 that may be used to store and provide performance data is illustrated. The system 400 may be a home networking system inside of a subscriber residence, such as a home phoneline networking alliance (HPNA) system. The system 400 includes a balun 402 operable to facilitate communication between a very high data rate digital subscriber line (VDSL) loop 430 of a video content provider network and a diplexer 404. The diplexer 404 includes a low-pass filter port 406 to facilitate communication with the balun 402. In addition, the diplexer 404 includes a high-pass filter port 410 to facilitate communication with a splitter 414. Further, the diplexer includes a common port 408 to facilitate communication with a home network gateway device 412. The diplexer 404 may be located within a subscriber residence, such as in a garage, or outside of a subscriber residence.

The splitter 414 includes an IN port 416 that facilitates communication with the diplexer 404. In addition, the splitter 414 includes OUT ports 418-422. Each OUT port 418-422 facilitates communication with a respective device. For example, the OUT port 418 facilitates communication with the device 424, the OUT port 420 facilitates communication with the device 426, and the OUT port 422 facilitates communication with the device 428. The devices 424-428 may include a Voice over Internet Protocol (VoIP) telephone, a personal computer, such as a desktop or laptop computer, a set-top box device, or any combination thereof.

In an illustrative embodiment, data packets, such as video content data packets, are communicated between the diplexer 404 and the VDSL loop 430 via the balun 402. The balun 402 may be coupled to the diplexer 404 via a coaxial cable and the balun 402 may be coupled to the VDSL loop 430 via twisted pair copper wire. Data packets are communicated between the balun 402 and other components of the system 400 via a low-pass filter port 406 of the diplexer 404.

The home network gateway device 412 may receive data packets from the VDSL loop 430 via the low-pass filter port 406 and the common port 408 of the diplexer 404 and then convert the data packets to a home network protocol, such as the home phoneline network alliance (HPNA) standard. The HPNA data packets may be sent to the common port 408 of the diplexer 404 at a higher frequency than VDSL data packets. The high frequency HPNA data packets may be communicated between the home network gateway device 412 and the splitter 414 via the high-pass filter port 410 of the diplexer 404. In addition, the home network gateway device 412 may receive HPNA data packets from the splitter 414 via the high-pass filter port 410 and the common port 408 of the diplexer 404. The home network gateway device 412 may convert the received high frequency HPNA data packets to low frequency VDSL packets. The low frequency VDSL packets may be communicated between the balun 402 and the home network gateway device 412 via the common port 408 and the low-pass filter port 406 of the diplexer 404. The diplexer 404 may be coupled to the home network gateway device 412 via coaxial cable, twisted pair copper wire, category 5 Ethernet cable, or any combination thereof.

Data packets may be communicated between the devices 424-428 and the diplexer 404 via the splitter 414. The splitter 414 may direct data packets received from one or more of the devices 424-428 via the respective OUT port 418-422 to the diplexer 404 via the IN port 416. Further, the splitter 414 may direct data packets received from the diplexer 404 to the appropriate OUT port 418-422 based on the intended destination device 424-428. Additionally, the splitter 414 may communicate data packets received from a particular device 424-428 to another one of the devices 424-428 via the respective OUT ports 418-422. For example, the device 424 may send data packets to the device 426 via the OUT port 418 and the OUT port 420. The splitter 414 may be coupled to the diplexer 404 via coaxial cable, twisted pair copper wire, category 5 Ethernet cable, or any combination thereof. In addition, the splitter 414 may be coupled to each of the devices 424-428 via coaxial cable, twisted pair copper wire, category 5 Ethernet cable, or any combination thereof.

A customer premises equipment (CPE) data collection server (not shown) may collect and analyze performance data associated with data packets received at the devices 424-428. For example, the home network gateway device 412, the devices 424-428, or any combination thereof, may send performance data related to each respective device 424-428 to the CPE data collection server via the VDSL loop 430. The CPE data collection server may identity a current problem associated with a network path between the balun 402 and one or more of the devices 424-428, predict a prospective problem associated with a network path between balun 402 and one or more of the devices 424-428, or any combination thereof.

The network path between the balun 402 and one or more of the network devices 424-428 may include a plurality of physical components. For example, a network path between the balun 402 and one or more of the network devices 424-428 may include the diplexer 404, the home network gateway device 412, the splitter 414, or any combination thereof. The network path between the balun 402 and one or more of the network devices 424-428 may also include coaxial cable, twisted pair copper wire, category 5 Ethernet cable, or any combination thereof. To illustrate, a network path between the balun 402 and the device 424 includes the diplexer 404, the home network gateway device 412, the splitter 414, and the wiring and/or cable connecting the respective devices. The network between the balun 402 and the device 424 may also include one or more connections, such as at least one connection associated with the balun 402, at least one connection associated with the diplexer 404, at least one connection associated with the home network gateway device 412, at least one connection associated with the splitter 414, at least one connection associated with the device 424, or any combination thereof. The performance data analyzed by the CPE data collection server may indicate a current or prospective problem associated with the wiring of the network path, the cable of the network path, one or more connections of the network path, a faulty physical component of the network path, or any combination thereof.

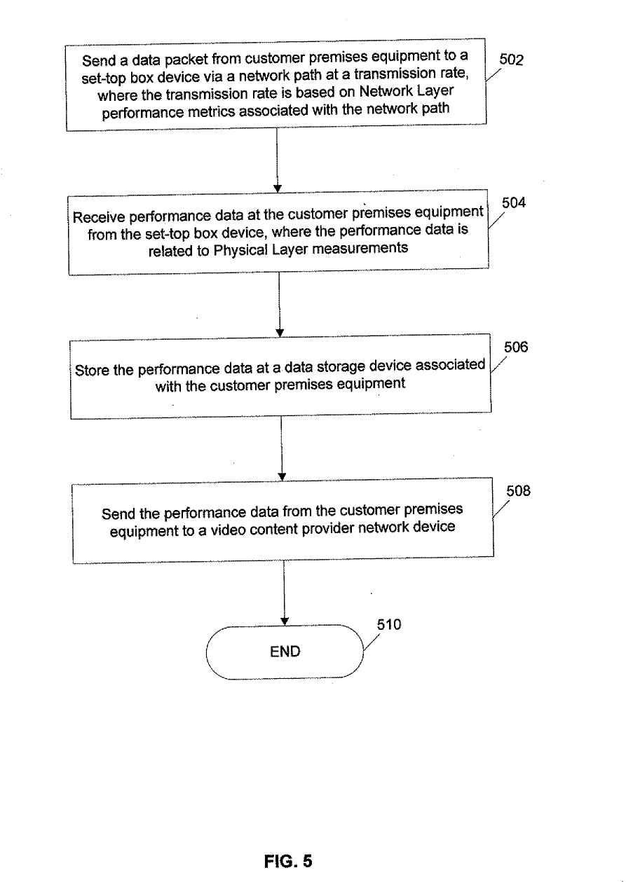

Referring to FIG. 5 a method of providing performance data is illustrated. At block 502, customer premises equipment sends a data packet to a set-top box device via a network path at a transmission rate. The data packet may be formatted according a home phoneline network alliance (HPNA) standard. Further, the transmission rate is based on Network Layer performance metrics associated with the network path. The Network Layer performance metrics may include code violation, error seconds, severe error seconds, Ethernet frame cyclic redundancy checks (CRCs), Ethernet frames dropped, or any combination thereof. In an illustrative embodiment, the customer premises equipment may be a home network gateway device located within a subscriber premises.

Moving to block 504, the customer premises equipment receives performance data from the set-top box device. The performance data is related to Physical Layer measurements. The Physical Layer measurements may relate to a rate of a data packet received at the set-top box device, a signal quality associated with a data packet received at the set-top box device, a number of errored data packets received at the set-top box device, or any combination thereof. In addition, the performance data may indicate a condition of a physical component of the network path.

Proceeding to block 506, the performance data is stored at a data storage device associated with the customer premises equipment. At block 508, the customer premises equipment sends the performance data to a video content provider network device. The method terminates at 510.

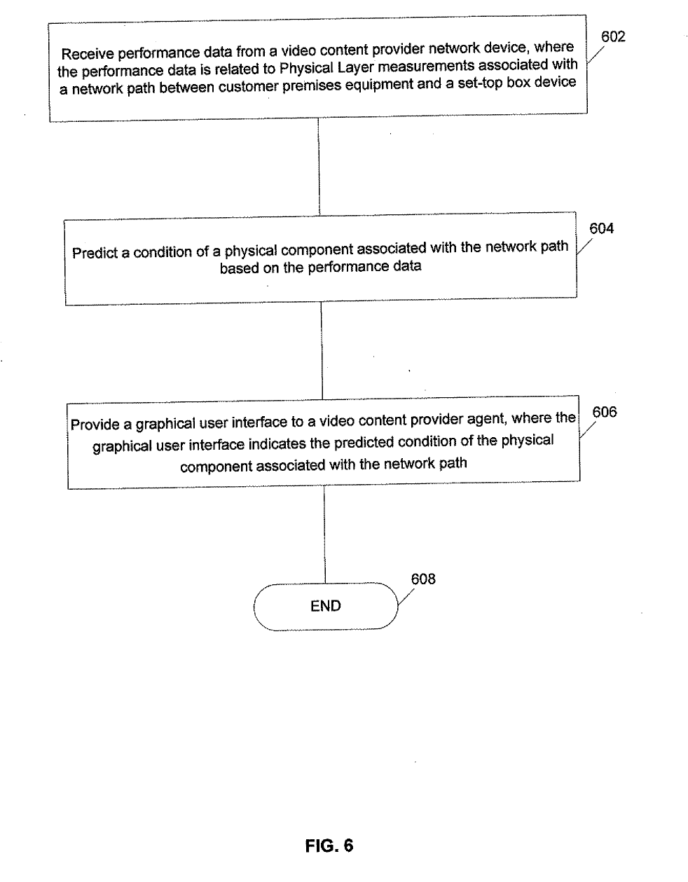

Referring to FIG. 6, a method of providing performance data is illustrated. At block 602, performance data is received from a video content provider network device. The performance data is related to Physical Layer measurements associated with a network path between customer premises equipment and a set-top box device. In a particular embodiment, the performance data may be received at a data collection server of a video content provider network from the customer premises equipment. In an illustrative embodiment, the data collection server may receive the performance data in response to sending a request for the performance data to the customer premises equipment. In an illustrative, non-limiting embodiment, the data collection server may send the request to the customer premises equipment independent of subscriber interaction.

Moving to block 604, a condition of a physical component associated with the network path is predicted based on the performance data. In an illustrative embodiment, the condition of the physical component associated with the network path may indicate a prospective faulty component of the network path. The prospective faulty component of the network path may include a loose connection, poor in-house wiring quality, a defective splitter, or any combination thereof. In an illustrative, non-limiting embodiment, the condition of the physical component associated with the network path indicates a prospective faulty physical component of the network path because the performance data is above a first threshold, because the performance data is below a second threshold, because the performance data is within a particular range, or any combination thereof. Further, the condition of the physical component associated with the network path may be predicted based on a trend related to performance data collected over a period of time, based on real-time or near real-time performance data, or any combination thereof.

Proceeding to block 606, a graphical user interface is provided to a video content provider agent, where the graphical user interface indicates the predicted condition of the physical component associated with the network path. The method terminates at 608.

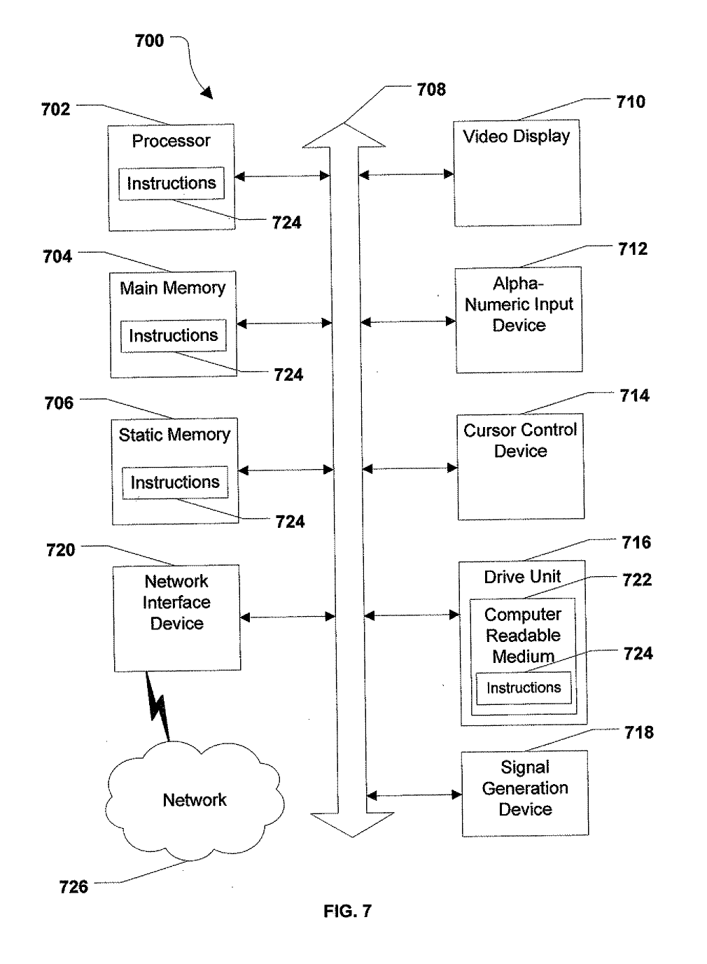

Referring to FIG. 7, an illustrative embodiment of a general computer system is shown and is designated 700. The computer system 700 can include a set of instructions that can be executed to cause the computer system 700 to perform any one or more of the methods or computer based functions disclosed herein. The computer system 700, or any portion thereof, may operate as a standalone device or may be connected, e.g., using a network, to other computer systems or peripheral devices, including a data collection server, a CPE management server, a CPE unit, a home network gateway device, a set-top box device, or a personal computing device as shown in FIGS. 1-4.

In a networked deployment, the computer system may operate in the capacity of an IPTV server, such as a video server or application server, or a set-top box device. The computer system 700 can also be implemented as or incorporated into various devices, such as a personal computer (PC), a tablet PC, a set-top box (S TB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 700 can be implemented using electronic devices that provide voice, video or data communication. Further, while a single computer system 700 is illustrated, the term “system” shall also be taken to include any collection of systems or sub-systems that individually or jointly execute a set, or multiple sets, of instructions to perform one or more computer functions.

As illustrated in FIG. 7, the computer system 700 may include a processor 702, e.g., a central processing unit (CPU), a graphics-processing unit (GPU), or both. Moreover, the computer system 700 can include a main memory 704 and a static memory 706 that can communicate with each other via a bus 708. As shown, the computer system 700 may further include a video display unit 710, such as a liquid crystal display (LCD), an organic light emitting diode (OLED), a flat panel display, a solid state display, or a cathode ray tube (CRT). Additionally, the computer system 700 may include an input device 712, such as a keyboard, and a cursor control device 714, such as a mouse. The computer system 700 can also include a disk drive unit 716, a signal generation device 718, such as a speaker or remote control, and a network interface device 720.

In a particular embodiment, as depicted in FIG. 7, the disk drive unit 716 may include a computer-readable medium 722 in which one or more sets of instructions 724, e.g. software, can be embedded. Further, the instructions 724 may embody one or more of the methods or logic as described herein. In a particular embodiment, the instructions 724 may reside completely, or at least partially, within the main memory 704, the static memory 706, and/or within the processor 702 during execution by the computer system 700. The main memory 704 and the processor 702 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 724 or receives and executes instructions 724 responsive to a propagated signal, so that a device connected to a network 726 can communicate voice, video or data over the network 726. Further, the instructions 724 may be transmitted or received over the network 726 via the network interface device 720.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

In accordance with various embodiments, the methods described herein may be implemented as one or more software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that software that implements the disclosed methods may optionally be stored on a tangible storage medium, such as: a magnetic medium, such as a disk or tape; a magneto-optical or optical medium, such as a disk; or a solid state medium, such as a memory card or other package that houses one or more read-only (non-volatile) memories, random access memories, or other re-writable (volatile) memories. The software may also utilize a signal containing computer instructions. A digital file attachment to e-mail or other self-contained information archive or set of archives is considered a distribution medium equivalent to a tangible storage medium. Accordingly, the disclosure is considered to include a tangible storage medium or distribution medium as listed herein, and other equivalents and successor media, in which the software implementations herein may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of providing performance data, the method comprising:
sending a first data packet from first customer premises equipment to a first set-top box device via a first network path at a transmission rate, the transmission rate based on Network Layer performance metrics associated with the first network path; and
receiving performance data at the first customer premises equipment from the first set-top box device, the performance data related to Physical Layer measurements;
wherein the performance data indicates a condition of a physical component of the first network path.

2. The method of claim 1, wherein the Physical Layer measurements relate to a rate of the first data packet upon receipt at the first set-top box device, a signal quality associated with the first data packet upon receipt at the first set-top box device, a number of errored data packets received at the first set-top box device, or any combination thereof.

3. The method of claim 1, wherein the Network Layer performance metrics include code violation, error seconds, severe error seconds, Ethernet frame cyclic redundancy checks (CRCs), Ethernet frames dropped, or any combination thereof.

4. The method of claim 1, wherein the first customer premises equipment sends a second data packet to a second set-top box device via a second network path at the transmission rate.

5. The method of claim 4, wherein the transmission rate is based on Network Layer performance metrics associated with the first network path, the second network path, or any combination thereof.

6. The method of claim 4, wherein the first data packet, the second data packet, or any combination thereof, is formatted according a home phoneline network alliance (HPNA) standard.

7. The method of claim 1, wherein the first customer premises equipment is a home network gateway device located within a subscriber premises.

8. The method of claim 7, wherein the first customer premises equipment receives information associated with the first data packet from a second customer premises equipment and wherein the second customer premises equipment is located outside of the customer premises.

9. A method of providing performance data, the method comprising:
receiving performance data from a video content provider network device, the performance data related to Physical Layer measurements associated with a network path between customer premises equipment and a set-top box device; and
predicting a condition of a physical component associated with the network path based on the performance data.

10. The method of claim 9, wherein a data collection server receives the performance data and wherein the performance data is stored at a data storage device associated with the data collection server.

11. The method of claim 10, wherein the data collection server sends a request to the customer premises equipment for the performance data.

12. The method of claim 11, wherein the set-top box device is associated with a subscriber and wherein the data collection server sends the request to the customer premises equipment independent of subscriber interaction.

13. The method of claim 9, wherein the condition of the physical component associated with the network path indicates a faulty physical component of the network path.

14. The method of claim 13, wherein the faulty physical component of the network path includes a loose connection, poor in-house wiring quality, a defective splitter, or any combination thereof.

15. The method of claim 13, wherein the condition of the physical component associated with the network path indicates a faulty physical component of the network path because the performance data is above a first threshold, because the performance data is below a second threshold, because the performance data is within a particular range, or any combination thereof.

16. The method of claim 9, further comprising providing a graphical user interface to a video content provider agent, the graphical user interface indicating the condition of the physical component associated with the network path.

17. The method of claim 9, wherein the condition of the physical component associated with the network path is predicted based on a trend related to performance data collected over a period of time, based on real-time or near real-time performance data, or any combination thereof.

18. A system to provide performance data, the system comprising:
processing logic and memory accessible to the processing logic, the memory including:
instructions executable by the processing logic to send a data packet to a set-top box device via a network path at a transmission rate, the transmission rate based on Network Layer performance metrics associated with the network path; and
instructions executable by the processing logic to receive performance data at the customer premises equipment from the set-top box device, the performance data related to Physical Layer measurements;
wherein the performance data indicates a condition of a physical component of the network path.

19. The system of claim 18, further comprising a data storage device adapted to communicate with the processor, wherein the data storage device stores the performance data received from the set-top box device.

20. The system of claim 19, wherein the memory includes instructions executable by the processing logic to send the performance data to a video content provider network device.

21. The system of claim 20, wherein the memory includes instructions executable by the processing logic to send the performance data to the video content provider network device in response to receiving a request from the video content provider network device relating to the performance data.

22. The system of claim 20, wherein the memory includes instructions executable by the processing logic to automatically send the performance data to the video content provider network device periodically, at a specified time, in response to a particular event, or any combination thereof.

23. The system of claim 18, wherein the network path includes coaxial cable, twisted pair copper wire, optical fiber, or any combination thereof.

24. A set-top box device comprising:
a processor and memory accessible to the processor, the memory including:
a performance data collection module executable by the processor to collect performance data associated with Physical Layer measurements, wherein the Physical Layer measurements are associated with data packets received at the set-top box device and wherein the performance data indicates a condition of a physical component of a network path associated with the set-top box device;
a performance data storage module executable by the processor to store the collected performance data at a data storage device associated with the set-top box device; and
a performance data delivery module executable by the processor to send performance data to customer premises equipment via the network path.

25. The set-top box device of claim 24, wherein the data packets received at the set-top box device are from an additional set-top box device, the customer premises equipment, or any combination thereof.

26. The set-top box device of claim 24, wherein the data packets are received at the set-top box device at a particular rate.

27. The system of claim 26, wherein the condition of the physical components of the network path relate to one or more connections associated with the network path, wire quality associated with the network path, a device associated with the network path, or any combination thereof.

28. The system of claim 27, wherein the one or more connections of the network path include a connection at the set-top box device, a connection at a splitter associated with the network path, a connection at a diplexer associated with the network path, a connection at the customer premises equipment, or any combination thereof.

29. A computer-readable medium having instructions to cause a processor to execute a method comprising:
sending a data packet from customer premises equipment to a set-top box device via a network path at a transmission rate, the transmission rate based on Network Layer performance metrics associated with the network path; and
receiving performance data at the customer premises equipment from the set-top box device, the performance data related to Physical Layer measurements;
wherein the performance data indicates a condition of a physical component of the network path.

30. The computer-readable medium of claim 29, wherein the Network Layer performance metrics are associated with a specified quality of video content.
